(19) United States
(12) Patent Application Publication
(10) Pub. No.: US 2012/0188567 A1
(43) Pub. Date: Jul. 26, 2012

(54) METHOD AND IMAGE-PROCESSING APPARATUS FOR PRESETTING OUTPUT LAYOUT AND MERGING IMAGES

(76) Inventor: Thomas SHENG, Hsinchu (TW)

(21) Appl. No.: 13/353,973

(22) Filed: Jan. 19, 2012

(30) Foreign Application Priority Data
Jan. 21, 2011 (TW) 100102337

(51) Int. Cl. G06F 15/00; G06K 9/36

(52) U.S. Cl. 358/1.9; 382/284

(57) ABSTRACT

A method for merging images comprises the following steps: displaying representative images of a first form image and a first ID image; according to a user input determining a position value of the first ID image relative to the first form image and storing the position value; and according to the position value merging a second ID image and one of the first form image and a second form image into a merged image. The present invention also provides an image-processing apparatus for presetting output layouts and merging images.

### CROSS REFERENCE TO RELATED APPLICATIONS

This application claims the benefit of the foreign application priority of Taiwan Application No. 100102337, which was filed on Jan. 21, 2011 and is incorporated herein by reference.

### BACKGROUND OF THE INVENTION

1. Field of the Invention

The present invention relates generally to an image-processing apparatus and method for merging document images, and especially relates to an image-merging method and an image-processing apparatus for presetting the output layout and automatically merging images. The apparatus applies a selected output layout to multiple sets of merged images, where the merged images contain images of personalized information and paper forms.

2. Description of the Prior Art

Commonly, in an ID copy mode provided in a digital copier, the ID card is required to be placed on the platen of the digital copier in order to proceed with the scanning or copying operations. In the event that the user wishes to copy both front and back sides of the ID card, the user must manually flip the ID card over at specific timings during the operations.

Even though there are some copiers which print out the print data after the completion of the scanning operations for both sides of the ID card, it is inevitable, that the user has to turn over the ID card by himself, in order for the images of the front side and back side to be printed on the same side of a print sheet. Especially when many official documents and application forms require applicants to append a copy of their ID cards to a specific box in the forms, the aforementioned copying mode can not satisfy the needs. In the conventional ID copy mode, the operator must take steps to configure the respective copy operation for the application form and the ID card. For example, after the operator receives the filled application form and the ID card from applicant, he may act as follows:

(1) copying the ID card and receiving hard copies of the ID card;

(2) cutting off the blank area around the front side and back side copies of the ID card and adhering the front side and back side copies of the ID card to a specific box of the application form; or positioning them inside the specific box; and

(3) placing the application form and the copies of the ID card on the platen of the copier and starting the copying operation.

Usually a massive amount of application documents are received by government agencies every day and if every document undergoes the above three steps, the processes of positioning and reproducing the documents will be time consuming, because “trial and error” technique needs to be implemented to correct the wrong-doings associated with the mis-action of the operator or the misplacement of the documents.

To save time, the operator may use two copiers respectively to copy the ID card and the application forms; however in such way not only the resources are occupied by one person, the operator may also make mistakes as he is turning back and forth between two machines.

### SUMMARY OF THE INVENTION

Accordingly, an object of the present invention is to provide a method and an apparatus for presetting output layouts and automatically merging images, which quickly and correctly merge the images of two document sheets and apply the settings for merging the images to other document images which are designated to have the same layout after being merged.

To achieve the afore-described object, the method of the present invention for merging images comprising the following steps: displaying representative images of a first form image and a first ID image; according to a user input determining a position value of the first ID image relative to the first form image and storing the position value; and according to the position value merging a second ID image and the one of the first form image and a second form image into a merge image.

To achieve the afore-described object, the image-processing apparatus for presetting output layouts and automatically merging images includes an image-input device, a display unit, an operation interface, a memory device, a processing unit and an image-output device. The image-input device provides a first ID image and a second ID image. The display unit displays representative images of the first ID image and a first form image. The operation interface receives a user input. The processing unit determines a position value of the first ID image relative to the first form image according to the user input and transmits the position value to the memory device; and merges the second ID image and one of the first form image and a second form image according to the position value into a merged image. The image-output device outputs the merged image of the second ID image and the selected one of the first form image and the second form image.

The method and image-processing apparatus of the present invention allows users to make copies of ID documents and forms in one single procedure, instead of copying them separately. In addition the method and image-processing apparatus of the present invention automatically rearrange the images of successive ID documents and forms to a desired output layout without user intervention.

These and other objects, features and advantages of the present invention will become apparent upon consideration of the following detailed description of the preferred embodiment that is illustrated in the various figures and drawings.

### BRIEF DESCRIPTION OF THE DRAWINGS

FIG. 1 is a flow chart of a method for merging images according to a first embodiment of the present invention.

FIG. 2 is a flow chart of a method for merging images according to a second embodiment of the present invention.

FIG. 3 is a flow chart of a procedure A for determining and storing a position value according to the first and second embodiments of the present invention.

FIG. 4 is a flow chart of a procedure B for merging a second ID image and one of a first form image and a second form image according to the first and second embodiments of the present invention.

FIG. 5 is a block diagram of an image-processing apparatus according to a preferred embodiment of the present invention.

FIGS. 6 to 10 illustrate a user interface of the image-processing apparatus used in a workflow for configuring output layouts according to the preferred embodiment of the present invention.

FIG. 11 is a schematic drawing of a workflow of the image-processing apparatus for merging a second form image and second ID images according to a preferred embodiment of the present invention.

FIGS. 12 to 15 illustrate a user interface of the image-processing apparatus used in a workflow for applying preset output layouts according to the preferred embodiment of the present invention.

### DETAILED DESCRIPTION

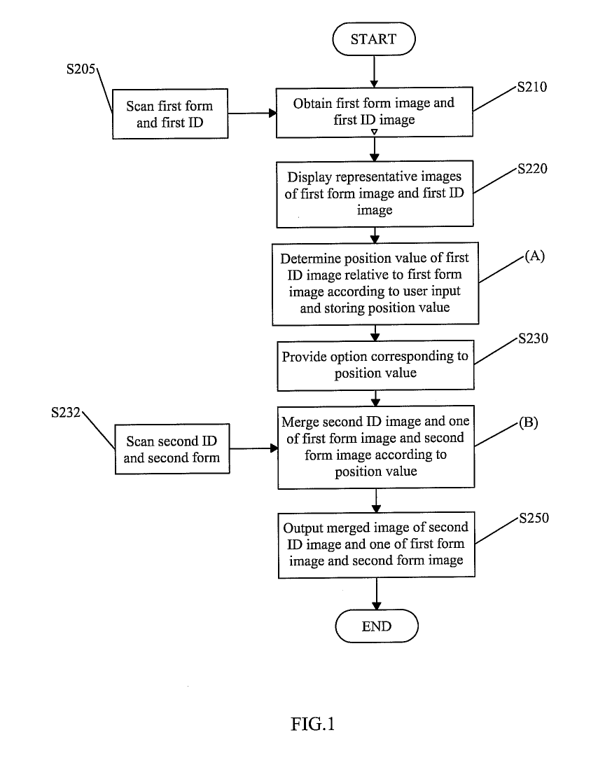

FIG. 1 is a flow chart of a method for merging images according to a first embodiment of the present invention. Referring to FIG. 1, the method according to the first embodiment comprises the following steps. First instep S220, representative images of a first form image corresponding to a first form and a first ID image corresponding to a first ID are displayed. The user, through an operation interface, designates a selected position where the representative image of the first ID image is being moved, or moves the representative image of the first ID image to the selected position. After the user input is received, referring to a procedure A, a position value of the first ID image relative to the first form image is determined and the position value is stored. Following procedure A, the method advances to a procedure B of merging a second ID image corresponding to a second ID and one of the first form image and a second form image according to the position value. Steps of the procedures A and B will be explained in detail in the later paragraphs.

In this embodiment, the method further comprises a step S250 where a merged image of the second ID image and one of the first form image and the second form image is outputted. If the second ID is accompanied with a second form identical to the first form or having a similar format to the first form, then the second form image corresponding to the second form is not necessarily acquired; instead, in procedure B the second ID image and the first form image are merged in to the merged image. The merged image of the second ID image and the first form image can be stored as a digital file in a memory device and/or the method advances to step S250 of outputting the merged image. In step S250, the merged image of the second ID image and the first form image is outputted. If the second form accompanied with the second ID is different from the first form, then the method advances to step S232 of acquiring the second form image corresponding to the second form. In procedure B the second ID image and the second form image are merged into the merged image. The merged image of the second ID image and the second form image is stored and/or the method advances to step S250 of outputting the merged image of the second ID image and second form image.

Before step S220, the method may further comprise a step S210 of obtaining the first form image and the first ID image. The first form image and the first ID image are obtained as a result of scanning the first form and the first ID in step S205. Moreover, before procedure B of merging the second ID image and selected one of the first form image and the second from image, the method may also comprise step S232 of scanning the second ID and the second form image.

In addition the method may further comprise the step S230 before the procedure B. In step S230, an option corresponding to the position value is provided. For example, an option of an output layout is provided for user selection. If many position values are stored already, an equivalent number of layout options are provided to allow users to select the most suitable output layout. In this embodiment, steps S205, S210 and S220 and procedure A constitute the process for configuring the output layout, and steps 230, S232 and S250 and procedure B constitute the process for applying the preset output layout to successive ID documents and forms.

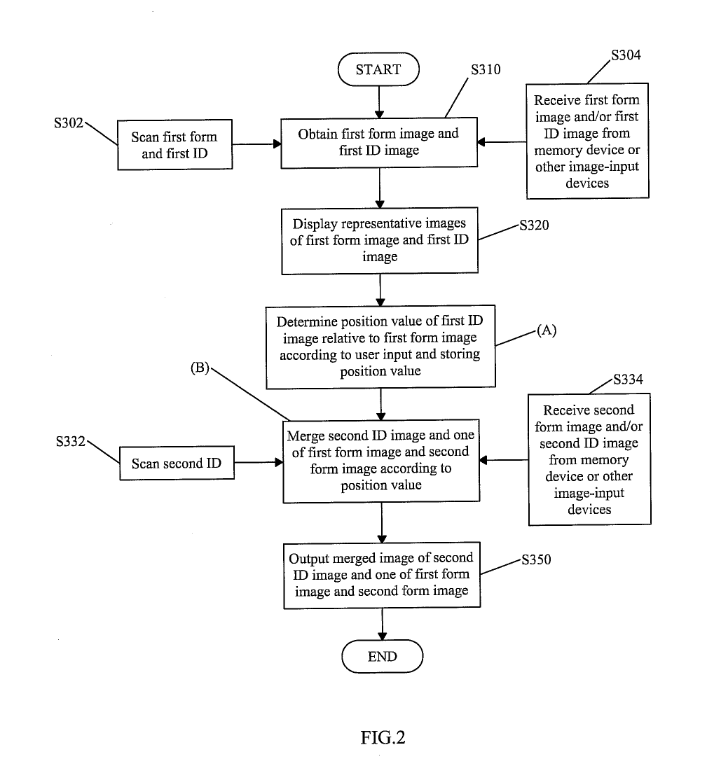

FIG. 2 is a flow chart of a method for merging images according to a second embodiment of the present invention. Referring to FIG. 2, in this embodiment steps S310, S320 and S350 and procedures A and B are identical to the steps S210, S220 and S250 and procedures A and B of the first embodiment. Therefore, the description regarding the same portions as those in the above-mentioned first embodiment is omitted. The step S230 of the first embodiment may also be executed in this second embodiment. The difference between the first embodiment and the second embodiment is in the steps of obtaining the first form image, the first ID image, the second form image and the second ID image.

In this embodiment, the first ID image and first form image are obtained by scanning the first ID as in step S302 and by receiving the first form image from the memory device or other image-input devices and sources as in step S304. Alternatively, step S304 may be executed alone, where both of the first form image and the first ID image are retrieved from the memory device or received from other image-input devices. And the way of obtaining the second form image and the second ID image is similar to that of obtaining the first form image and the first ID image. In step S332 the second ID image is obtained by scanning the second ID and in step S334 the second form image is retrieved from the memory device or received from other image-input devices and sources. Alternatively, the step S334 alone may be executed, where both of the second form image and the second ID image are retrieved from the memory device or other input devices.

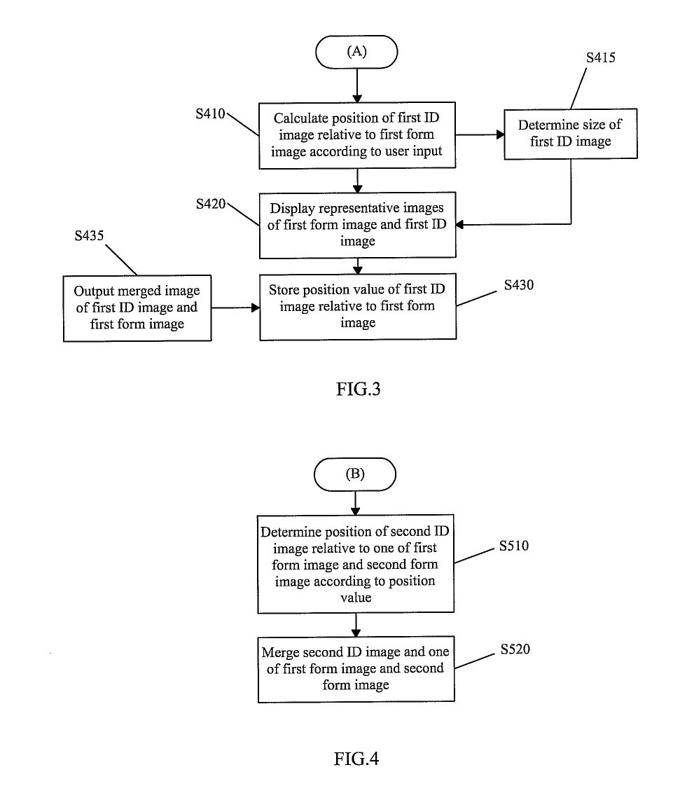

FIG. 3 is a flow chart of the procedure A for determining and storing the position value according to the first and second embodiments of the present invention. Referring to FIG. 3, the procedure A for determining and storing the position value of the first ID image relative to the first form image comprises the following steps. In step S410, after the user input for designating the placement of the first ID image is received, a position of the first ID image relative to the first form image is determined. In step S420, a representative image of the merged image of the first form image and the first ID image is displayed. In step S430 the position value of the first ID image relatively to the first form image is stored in the memory device. In addition to that the user moves the first ID image to another position, the user may change the size of the first ID image in order for the first ID image to fit into a designated area in the first form image. In other words, the size of the first ID image is determined according to a user input, as in step S415.

Besides, in order to verify the position of the first ID image relative to the first form image and the resulting output layout, the method further comprises a step S435 where the merged image of the first ID image and the first form image is outputted, for example, printed.

FIG. 4 is a flow chart of the procedure B for merging the second ID image and one of the first form image and the second form image according to the first and second embodiments of the present invention. Referring to FIG. 4, the procedure B for merging the second ID image and the selected one of the first form image and the second form image according to the position value comprises the following steps. In step S510 a position of the second ID image relative to one of the first form image and the second form image according to the position value is determined. In step S520 the second ID image and the selected one of the first form image and the second form image are merged. That is, whether the second ID image is selected to be combined with the first form image or the second form image, the second ID image is merged according to the position value determined as a result of calculating the relative position of the first ID image to the first form image in the procedure. In the merged image of the second ID image and the selected one of the first form image and the second form image, the second ID image is placed at a position corresponding to the position value.

In the following paragraphs, the method of the present invention for merging images is implemented in a multi-functional image-processing apparatus; however, the present invention is not limited to this, but can also be implemented in workgroups consisting of a plurality of single-functional image-processing apparatuses, such as scanners and printers.

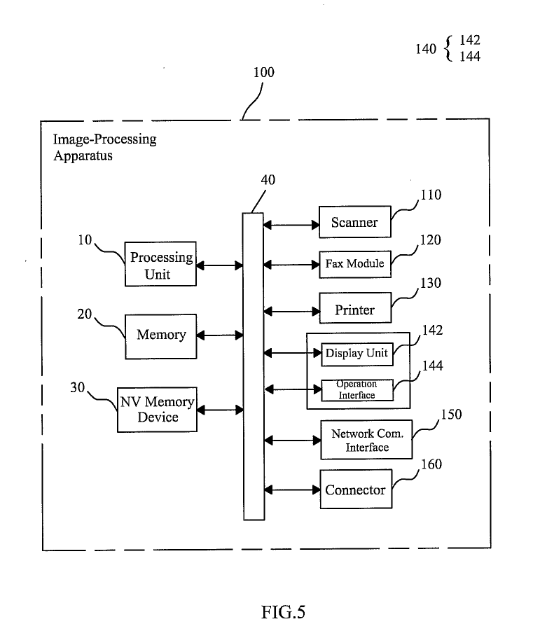

FIG. 5 is a block diagram of an image-processing apparatus 100 according to a preferred embodiment of the present invention. Referring to FIG. 5, in this embodiment the image-processing apparatus 100 for presetting output layouts and automatically merging images includes a processing unit 10, a memory 20, a non-volatile memory device 30, a bus 40, a scanner 110, a fax module 120, a printer 130, a user interface 140, a network communication interface 150 and a connector 150 for connecting external devices. The processing unit 10 controls the operations of the apparatus 100 and processes data. The memory 20, for example, a random-access memory, RAM, temporarily stores data. The non-volatile memory device 30, e.g., non-volatile RAM, built-in hard drives, flash drives, and etc., stores digital data. The bus 40 transmits data and control signals.

The scanner 110, which may be a scanner module or an optical module, scans documents and generates images corresponding to the documents. The scanner 110 may further comprise an automatic document feeder (ADF) for automatically feeding a stack of document sheets in a batch-scanning operation. The fax module 120, e.g., a fax modem, transmits and receives text and graphic messages via telephone lines. The printer 130 prints data. The user interface 140 displays information of the apparatus 100 and receives a user input, by which the user can operate the apparatus 100. In this embodiment, the user interface 140 includes a display unit 142 and an operation interface 144. Alternatively the display unit 142 may be a touch panel. The network communication interface 150 transmits signals and data to and receives signals and data from an external terminal, via the network. The network communication interface 150 could be a LAN or internet communication interface. The connector 160 connects directly to an external electronic device, such as a personal computer, printer, external hard drive, USB drive, mobile device, and etc. The apparatus 100 transmits and receives signals and data to and from the external electronic device via the connector 160. Therefore, the image-input device of the present invention could be any of the scanner 100, fax module 120, network communication interface 150 and connector 160; and the image-output device could be any of the fax module 120, printer 130, network communication interface 150 and connector 160.

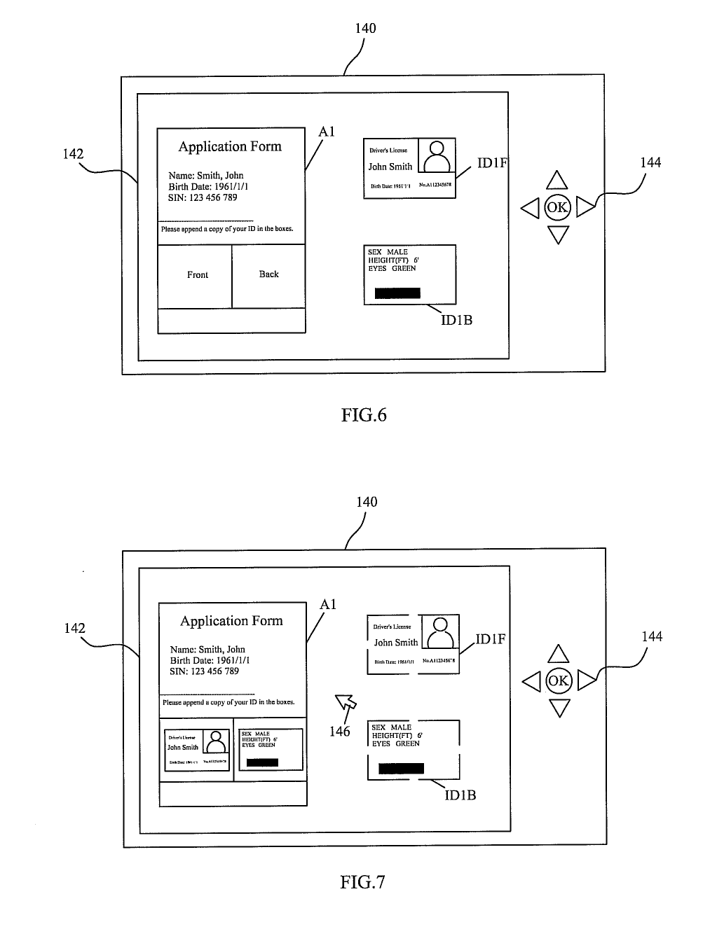

FIGS. 6 to 10 illustrate the user interface of the apparatus 100 used in the workflow for configuring output layouts according to the preferred embodiment of the present invention. Referring to FIG. 6, after the processing unit 10 processes a first form image corresponding to a first form and first ID images corresponding to a first ID, a representative image A1 of the first form image and representative images ID1F and ID1B of the first ID images are displayed on the display unit 142. The representative images ID1F and ID1B represent the front side and back side images of the first ID. There are many ways for the processing unit 10 to obtain the first form image and the first ID images. For example, the first form image and the first ID images may be generated as the result of the scanner 110 scanning the first form and the first ID. Or the first form image and the first ID images are retrieved by the processing unit 10 from the non-volatile memory device 30. Or the processing unit 10 receives the first form image and the first ID images from outside via the fax module 120, network communication interface 150 or connector 160.

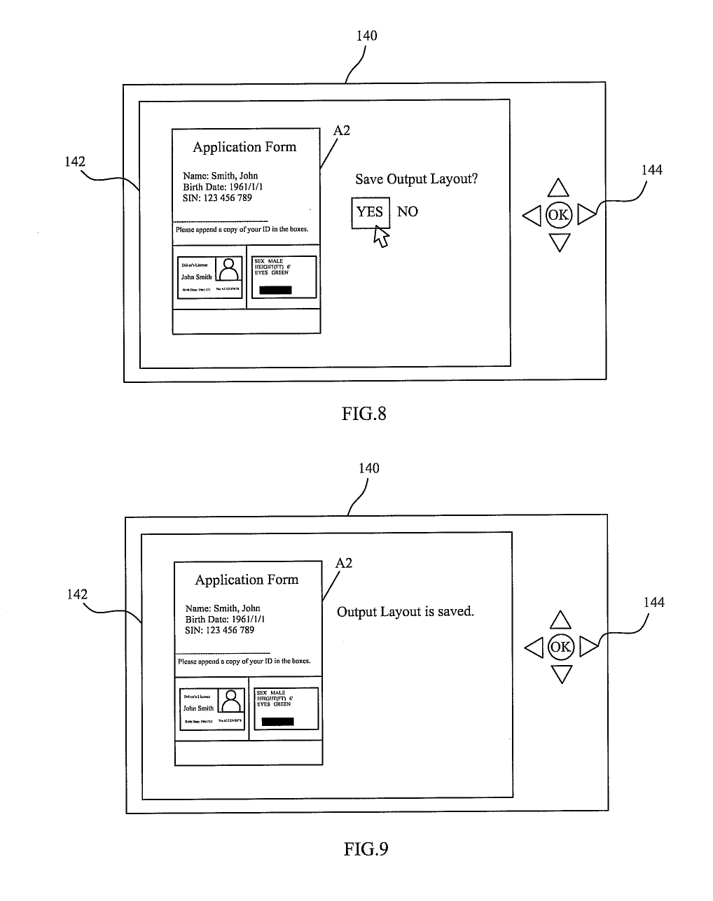

Referring to FIG. 7, the user instructs a designated position or directly moves the representative images ID1F, ID1B of the first ID image to the designated position by using the operation interface 144, for example arrow buttons and cursors. As shown in FIG. 7, the user uses a computer mouse to move the cursor 146 and drags the representative images ID1F, ID1B to the designated position on the representative image A1 of the first form image. When receiving the user input, the processing unit 10 determines position values of the first ID images relative to the first form image accordingly. The user also could change the respective size of the representative images ID1F, ID1B in order for them to fit into the designated area on the first form image. The processing unit 10 determines the respective size of the first ID images relative to the first form image. Referring to FIG. 8 and FIG. 9, the user may choose to save the output layout of a merged image of the first form image and the first ID images. On the display unit 142 a representative image A2 of a merged image of the first form image and the first ID images is displayed, to allow the user to verify the output layout. After verification, the user could choose to save the output layout of the representative image A2. When receiving confirmation, the processing unit 10 transmits the position values of the first ID images relative to the first form image to the non-volatile memory device 30.

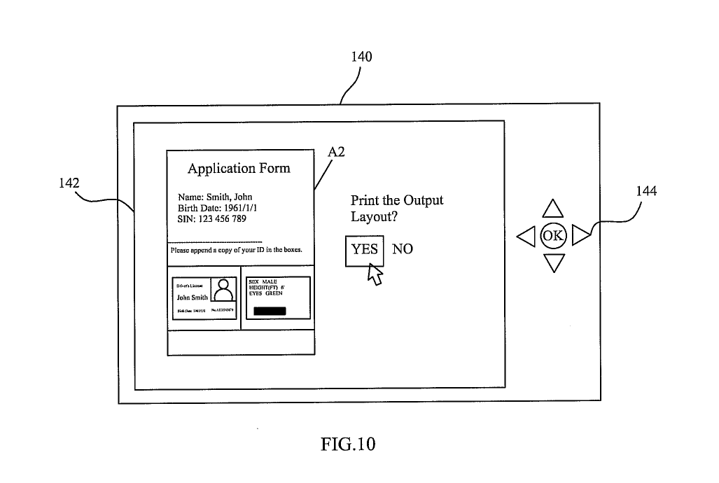

In order for the user to check the output layout closely, the apparatus 100 can also output the merged image of the first ID images and the first form image by printing out the image data, as shown in FIG. 10. In this embodiment, after the user selects the option of printing out the merged image, the processing unit 10 transfers print data of the merged image to the printer 130. The printer 130 prints out the data on a sheet of paper. The user thus can check a hard copy of the merged image. The printer 130 is used as an example of the image-output device. Alternatively, the data of the merged image may be outputted to a PC, such the user may view the image on a bigger screen.

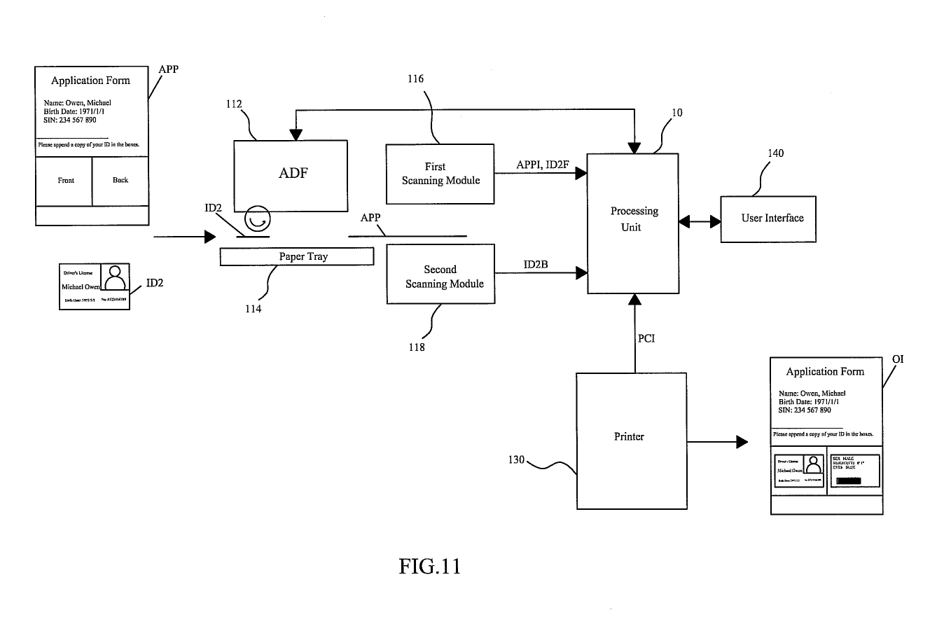

The workflow for configuring the output layouts on the apparatus 100 is described in the foregoing paragraphs. In the following paragraphs, a workflow for applying preset output layouts and automatically merging images will be explained. FIG. 5 and FIGS. 11 to 15 will be referred. FIG. 11 is a schematic drawing of a workflow of the apparatus 100 for merging a second form image and second ID images according to a preferred embodiment of the present invention. In this embodiment, the second form image and the second ID images are acquired by scanning a second form and a second ID with the scanner 110. However, as mentioned in the foregoing paragraphs, the second form image and/or the second ID images may, alternatively, be retrieved from the non-volatile memory device 30 and received from other image-input devices. In this embodiment a merged image of the second ID images and the second form image is outputted by the printer 130, but the present invention is not limited by this. The merged image can also be outputted by other image-output devices. Referring to FIG. 11, after the user loads the second form APP and the second ID ID2 in a paper tray 114 of the apparatus 100, the ADF 112 transports the second form APP and the second ID ID2 in sequence past a first scanning module 116 and a second scanning module 118. The first scanning module 116 scans the front sides of the second form APP and the second ID ID2 and the second scanning module 118 scans the back sides of the second form APP and the second ID ID2. When the scanning operation is completed, the ADF 112 discharges the second form APP and the second ID ID2, and the first scanning module 116 and the second scanning module 118 send image data APPI, ID2F, ID2B corresponding to the second form APP and the second ID ID2 to the processing unit 10 for image processing.

The processing unit 10 merges the second ID images ID2F, ID2B and the second form image APPI into a merged image OI according to the position value previously stored, where the processing unit 10 uses the position value to determine the positions of the second ID images ID2F, ID2B in the merged image OI. Afterwards, the processing unit 10 may process data of the merged image OI into print data PCI and send the print data PCI to the printer 130, or may process the data of the merged image into a data file and store the data file in the non-volatile memory device. The printer 130 prints the merged image OI on a sheet of paper. In this embodiment, the second ID images ID2F, ID2B and the second form image APPI are merged; however the second ID images ID2F, ID2B and the first form image can also be merged in the same manner. Under the circumstances that the second ID ID2 is accompanied with or is destined to be appended to a form identical or similar to the first form, since it would not be necessary to acquire the second form image APPI, the second ID images ID2F, ID2B are combined with the first form image previously stored in the memory 20 or the non-volatile memory device 30 to form the merged image.

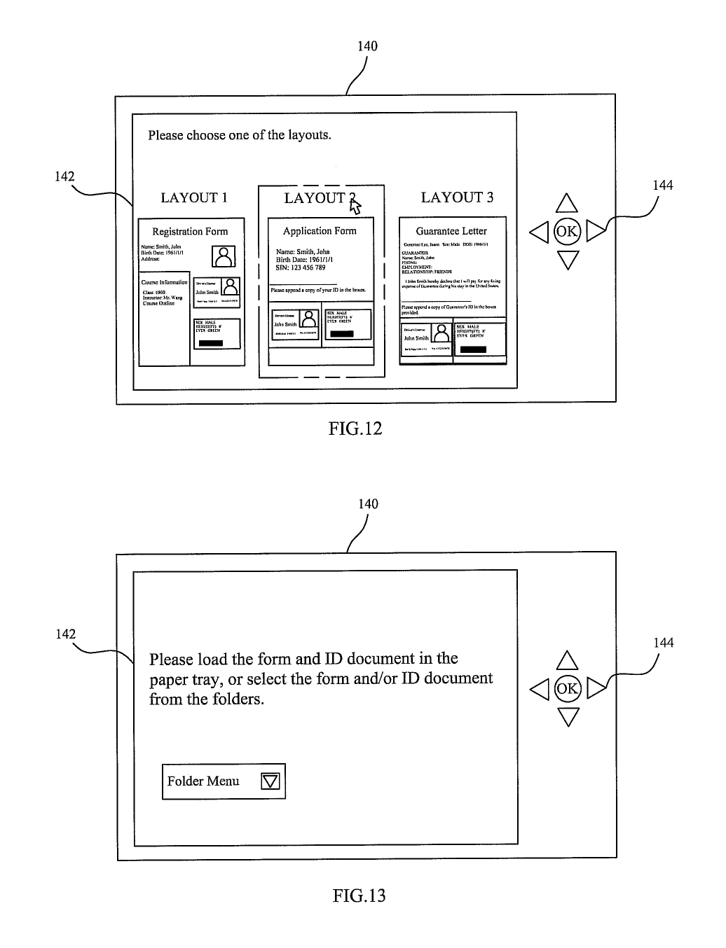

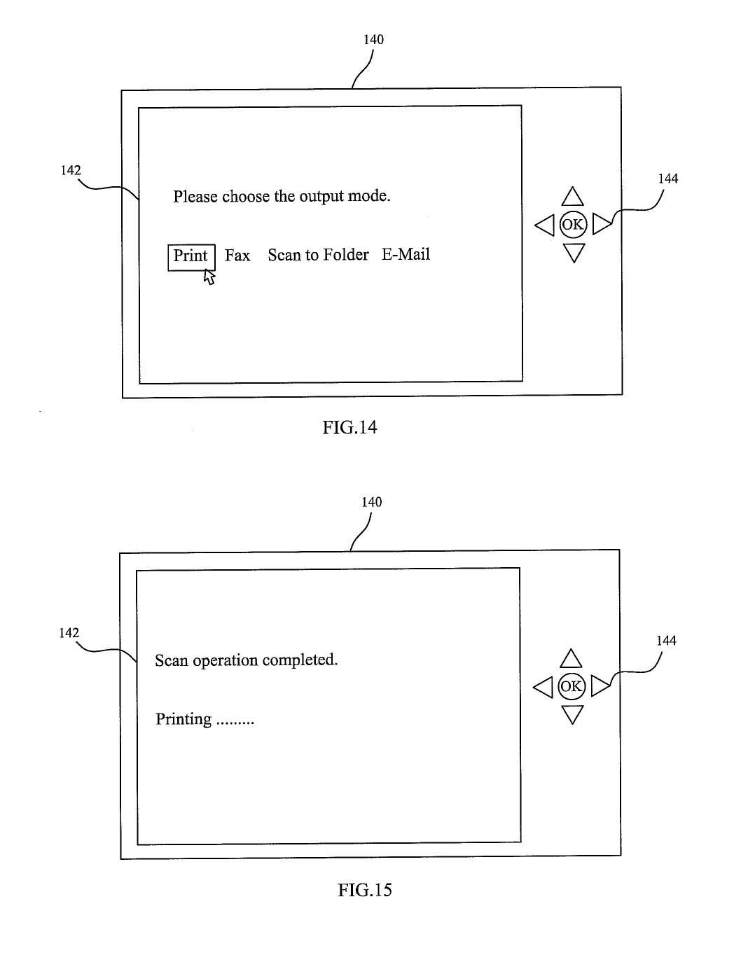

FIGS. 12 to 15 illustrate a user interface 140 of the image-processing apparatus 100 used in a workflow for applying preset output layouts according to the preferred embodiment of the present invention. Referring to FIG. 12, the user interface 140 provides an option corresponding to the previously stored position value, for example, an option of the output layout of the merged image of the first ID image and the first form image corresponding to the position value. If many position values are stored already, an equivalent number of output layout options are provided to allow users to select the most suitable output layout, such as layout 1, layout 2 and layout 3 in FIG. 12. The user interface 140 also provides selectable parameters for image input and output, as shown in FIGS. 13 and 14, and conveys the status information of the apparatus 100, as shown in FIG. 15.

The method and image-processing apparatus of the present invention for presetting output layouts and merging images shorten the time for processing personalized documents and remove the steps of separately copying the ID documents and forms and repeatedly arranging the documents to construct a certain layout. Instead, the users only need to configure for a first set of documents; and the successive documents will use the same output layout.

While the present invention has been described with respect to a limited number of embodiments, it is to be understood that the present invention is not limited to the disclosed exemplary embodiments. It is intended that the appended claims cover all modifications, equivalent structures and variations as fall within the true spirit and scope of this present invention. The specification and drawings are, accordingly, to be regarded in an illustrative rather than a restrictive sense.

What is claimed is:

1. A method for merging images used in an image-processing apparatus, comprising steps of:
displaying representative images of a first form image and a first ID image;
determining a position value of the first ID image relative to the first form image according to a user input and storing the position value; and
merging a second ID image and one of the first form image and a second form image according to the position value.

2. The method of claim 1, wherein before the step of displaying the representative images of the first form image and the first ID image, the method further comprises a step of:
scanning a first form and a first ID to obtain the first form image and the first ID image.

3. The method of claim 1, wherein before the step of displaying the representative images of the first form image and the first ID image, the method further comprises steps of:
retrieving the first form image from a memory device; and
scanning a first ID to obtain the first ID image.

4. The method of claim 1, wherein the step of determining and storing the position value of the first ID image relative to the first form image comprises:
calculating a position of the first ID image relative to the first form image according to the user input;
displaying a representative image of a merged image of the first form image and the first ID image; and
storing the position value of the first ID image relative to the first form image.

5. The method of claim 4, further comprising a step of:
determining a size of the first ID image according to the user input.

6. The method of claim 4, further comprising a step of:
outputting the merged image of the first ID image and the first form image.

7. The method of claim 6, wherein the step of merging the second ID image and one of the first form image and the second form image comprises:
determining a position of the second ID image relative to one of the first form image and the second form image according to the position value; and
merging the second ID image and one of the first form image and the second form image into a merged image.

8. The method of claim 1, further comprising steps of:
scanning a second ID to obtain the second ID image; and
scanning a second form to obtain the second form image.

9. The method of claim 1, before the step of merging the second ID image and one of the first form image and the second form image, the method further comprises a step of:
providing an option corresponding to the position value for user selection.

10. The method of claim 1, further comprising a step of:
outputting a merged image of the second ID image and one of the first form image and the second form image.

11. An image-processing apparatus for presetting output layouts and automatically merging images comprising:
an image-input device providing a first ID image and a second ID image;
a display unit displaying representative images of the first ID image and a first form image;
an operation interface receiving a user input;
a memory device;
a processing unit determining a position value of the first ID image relative to the first form image according to the user input, transmitting the position value to the memory device, and merging the second ID image and one of the first form image and a second form image according to the position value; and
an image-output device outputting a merged image of the second ID image and one of the first form image and the second form image.

12. The apparatus of claim 11, wherein the image-input device is a scanner operable to scans a first ID, a second ID, a first form and a second form, and generating the first ID image, the second ID image, the first form image and the second form image correspondingly.

13. The apparatus of claim 11, wherein the memory device further stores the first form image and the processing unit retrieves the first form image from the memory device.

14. The apparatus of claim 11, wherein the processing unit further determines a size of the first ID image according to the user input.

15. The apparatus of claim 11, wherein the display unit further displays a representative image of a merged image of the first ID image and the first form image; and the processing unit further transmits the position value of the first ID image to the memory device.

16. The apparatus of claim 15, wherein the image-output device further outputs the merged image of the first ID image and the first form image.

17. The apparatus of claim 11, wherein the processing unit determines a position of the second ID image relative to one of the first form image according to the position value and the second form image and merges the second ID image and one of the first form image and the second form image into a merged image.

18. The apparatus of claim 11, wherein the operation interface provides an option corresponding to the position value.

19. The apparatus of claim 11, wherein the image-output device comprises at least one of a printer, a fax module, a network communication interface and a connector.
